(19) United States
(12) Patent Application Publication
(10) Pub. No.: US 2009/0109864 A1
(43) Pub. Date: Apr. 30, 2009

(54) Network card testing system

(75) Inventors: Sheng-Shi Wang, Tianjin (CN); Sui-Yi Ma, Tianjin (CN); Tom Chen, Taipei (TW); Win-Harn Liu, Taipei (TW)

Correspondence Address: RABIN & Berdo, PC, 1101 14TH STREET, NW, SUITE 500, WASHINGTON, DC, 20005, US

(73) Assignee: INVENTEC CORPORATION, Taipei (TW)

(21) Appl. No.: 11/976,372

(22) Filed: Oct. 24, 2007

(51) Int. Cl. G06F 11/00

(52) U.S. Cl. 370/249

(57) ABSTRACT

A network card testing system includes a network card testing set, a network card, and a network card testing software. A plurality of twisted pairs in the network card testing set is connected with one another to form a loop. When the network card testing set is connected to the network card, a test loop is formed. The network card testing software is executed by a computer, and test data packets are directly generated and transferred through a data-link layer according to different testing strategies and network card information. And then, the test data packets are sent back through the formed test loop, and test results are calculated according to the test data packets.

### BACKGROUND OF THE INVENTION

1. Field of Invention

The present invention relates to a network card testing system, and more particularly, to a network card testing system with a test loop formed by an external testing set.

2. Related Art

According to different communication techniques, layouts, and transmission media, there are different network architectures, such as Ethernet, Token Ring, Fiber Distributed Data Interface (FDDI), Fast Ethernet, and Wireless Network. These networks have special forming architectures and support operating bandwidths. For example, Ethernet uses cheap twisted pairs as signal transmission medium. Meanwhile, as Ethernet has the characteristics of simple wiring and being easy to build and expand the network, it has become the most popular network currently. In the early period, Ethernet adopts a half-duplex network card (100 Base-T network card), and the support transmission bandwidth is 10 Mbit/s. With the development of network technology, Fast Ethernet technique is derived from Ethernet, in which the network card at most can support the transmission rate up to 100 Mbit/s or even to 10 Gigabit.

As the function and the performance of the network card attract more and more attention, how to effectively and accurately test the network card becomes an important issue. Currently, network card test mainly includes two parts, i.e., function test and performance test. The common used method for testing network card is performed by P2P data communication through Socket technique of TCP/IP protocol. However, this kind of tests has three disadvantages as follows. First, there are two network nodes that require to allocate IP address additionally, so as to transmit digital data, such that the operation is complex and time-consuming. Second, an additional server (or another computer) and corresponding network equipments (such as, hub/exchanger/router) are required to mount the network, and the mounting network environment also has influence on the test results. Third, the test is based on the TCP/IP protocol, and the test performance is limited by the performance of the network protocol and cannot really test the information, such as packet lost and retransmission, during actual operation of the network card. Additionally, a part of the method for performing the network card test is transmitting data packets through local address to perform loop-back test. Though no additional physical network environments is required to be mounted for such a test method, the method is also based on the TCP/IP protocol, in which the transmitted data packets are not transmitted downward to the Ethernet, and the data for testing cannot reach the data-link layer of the network card.

### SUMMARY OF THE INVENTION

In view of the above disadvantages of the network card such as complex and time-consuming operation during test, requiring additional network equipments, and failing to test the performance of lower level, an object of the present invention is to transmit test data packet directly through lower level and receive the test data packet transferred by itself by the test loop, so as to self-test the efficacy of the network card for transceiving and processing packets.

In order to achieve the above purposes, the network card testing system of the present invention includes a network card testing set, a network card under test, and a network card testing software. The network card testing set includes a network cable connector and a plurality of twisted pairs. One ends of the twisted pairs are disposed in a stagger arrangement and inserted in the network cable connector, and the other ends directly connect the twisted pairs with one another respectively or through metal sheets. The network card is installed in a computer or an electronic device, and connected to the network cable connector through a connection port on the network card to form a test loop. The network card testing software is executed through the computer or the electronic device to perform the following steps: first, generating test data packets with different lengths according to network card information and a plurality of testing strategies; next, sending the test data packets to the network card through a lower level driver (LLD); then, receiving the test data packets sent back to the network card through the test loop; and finally, calculating test results, for example, throughput and packet lost rate, according the sent-back test data packets.

In a network card testing system according to a preferred embodiment of the present invention, the network card information includes network card name, network card MAC address, and network card maximal transmission unit (MTU), and the width of the network card MTU is selected from the aggregate consisting of 64, 128, 256, 512, 1024, 1280, and 1500 bytes.

In a network card testing system according to a preferred embodiment of the present invention, the testing strategies include a pressure test, a packet lost rate test, and a network simulation test. When the testing strategy is the pressure test, the MTU with the maximal width is adopted; when the testing strategy is the packet lost rate, the MTU with the minimal width is adopted; and when the testing strategy is the network simulation, the length of the MTU is dynamically adjusted.

In a network card testing system according to a preferred embodiment of the present invention, the LLD can be a Network Driver Interface Standard (NDIS) protocol or a PF_PACKET Socket procedure.

As described above, the network card testing system forms a test loop through an external network card testing set, and tests the network card directly by transmitting test data packets through lower level, thereby avoiding the influence on the accuracy of the network cart test due to the limitation of the network communication protocol or the quality problems of the built network environment, so as to really detect the function and the performance of the network card.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1A is a schematic architectural view of a network card testing system;

FIG. 1B is a schematic architectural view of a network card testing set in FIG 1A;

FIG. 2 is a flow chart of the execution steps of a network card testing software;

FIG. 3 is a schematic architectural view of a layered network of the network card testing system; and

FIG. 4 is a schematic view of fields of test data packets.

### DETAILED DESCRIPTION OF THE INVENTION

The detailed features and practice of the present invention will be described in detail below in the following preferred embodiments. However, the concepts of the present invention can also be applied to other scopes. The following embodiments are only used for illustrating the objects and implementations of the present invention, instead of limiting the scope thereof.

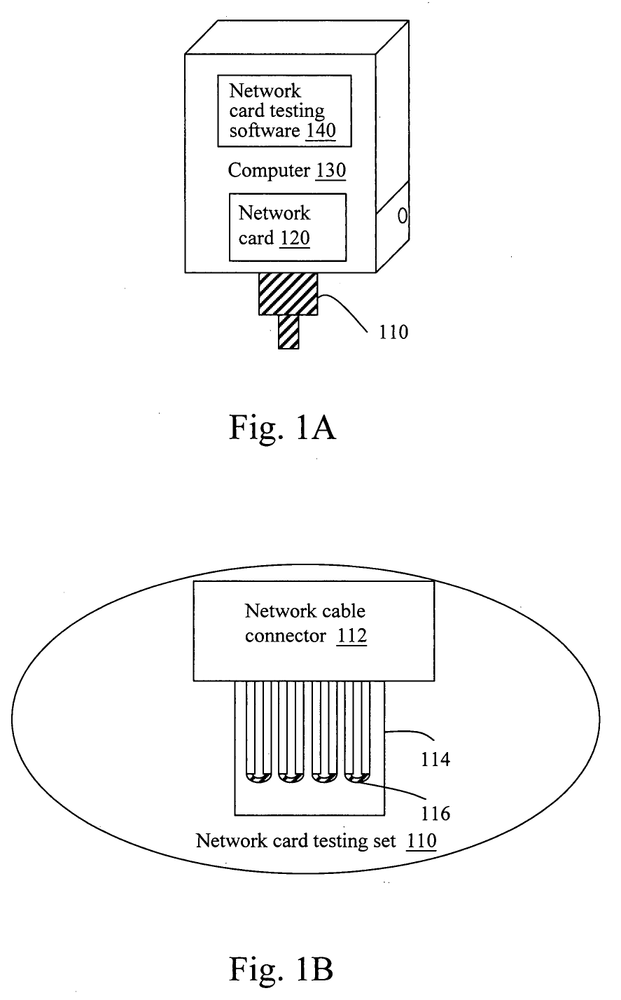

FIG. 1A is a schematic architectural view of a network card testing system. Referring to FIG. 1A, as for the hardware architecture of the network card testing system, for example, a network card 120 under test is installed in a computer 130, and connected with a special network card testing set 110. The network card testing set 110 has a loop structure, and after the network card testing set 110 is connected to a connection port on the network card, a test loop is formed. The computer 130 executes a network card testing software 140 to generate a plurality of test data packets, and the test data packets are transmitted to the network card testing set 110 through the network card 120, and then sent back to the network card through the formed test loop. After a period of time, the computer calculates the number of the received (sent-back) test data packets and calculates whether the function of the network card for transmitting packets is normal according to the number of the generated test data packets, so as to obtain the transmission performance of the network card.

Accordingly, in order to make the transmitted test data packets sent back to the local host, a special loop structure is designed on the network card testing set. FIG. 1B is a schematic architectural view of a network card testing set in FIG. 1A. Referring to FIG. 1 B, a standard 100BASE-T-RJ45 (RJ45 for short hereinafter) network cable has 8 twisted pairs, in which the first and the second ones are used for transmitting data, the third and the sixth ones are used for receiving data, and the fourth, the fifth, the seventh, and the eighth ones are twisted pairs for bidirectional transmission. The network card testing set 110 of this embodiment is composed of a network cable connector 112 (i.e., RJ45 connector) and a plurality of twisted pairs 114 (i.e., 8 twisted pairs in the RJ45 network cable). One ends of the 4 pairs of twisted pairs are disposed in a stagger arrangement and inserted in the network cable connector 112, and the other ends connect the twisted pairs 114 in pairs with one another respectively through metal sheets 116. In other embodiments, the 8 (4 pairs of) twisted pairs are directly connected with one anther to form an electrical loop.

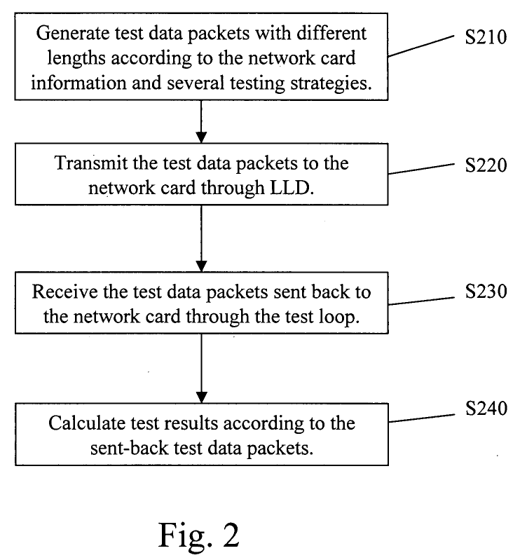

FIG. 2 is a flow chart of the execution steps of a network card testing software. Referring to FIG. 2, the computer or the electronic device executes the network card testing software to perform the following steps.

First, test data packets with different lengths are generated according to network card information and several testing strategies (Step S210). Next, the test data packets are transmitted to the network card through LLD (Step S220). Then, the test data packets sent back to the network card are received through the test loop (Step S230). And finally, a test result including throughput of transmitting the packets and packet lost rate is calculated according to the sent-back test data packets (Step S240).

Accordingly, the network card information includes network card name, network card MAC address, and network card MTU, which is the information extracted by a automatically sent network instruction by executing the network card testing software. Additionally, the testing strategies include a pressure test for testing whether the network card is wrong in electric coding during transmitting a large amount of data; a packet lost rate test for calculating whether the network card has the packet lost phenomenon by comparing the number of the sent test data packets and the number of the received test data packets and calculating the ratio of packet lost in unit time; and a network stimulation test for generating test data packets with different widths by dynamically changing the MTU, so as to stimulate the packets transmitted by different hosts, so as to make the test more similar to a true network environment. For different testing strategies, proper MTU is adjusted to perform the test. When the testing strategy is the pressure test, the MTU with the maximal width is adopted; when the testing strategy is the packet lost rate test, the MTU with minimal width is adopted; and when the testing strategy is the network stimulation test, the length of the MTU is dynamically adjusted.

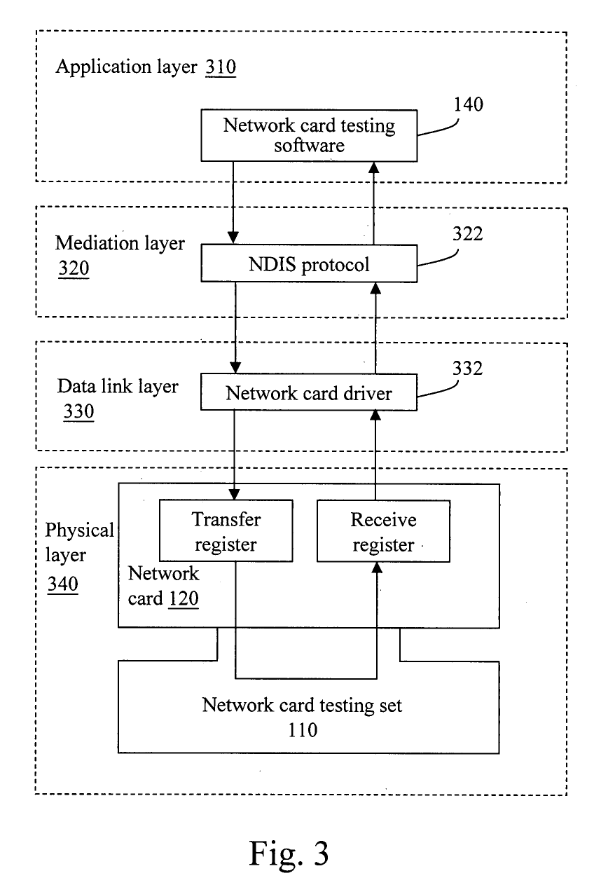

FIG. 3 is a schematic architectural view of a layered network of the network card testing system. Referring to FIG. 3, the network card testing software 140 is software for an application layer 310, and the computer executes the network card testing software 140 to test whether the function of the network card 120 is normal, so as to test the performance of the network card 120 for processing data packets. Different from the TCP protocol, this embodiment directly calls a network card driver 332 of a data link layer 330 through NDIS protocol 322 of a mediation layer 320 to generate test data packets. Under Linux system, low level raw packets can be sent directly by the data link layer 330 through PF_PACKET socket procedure.

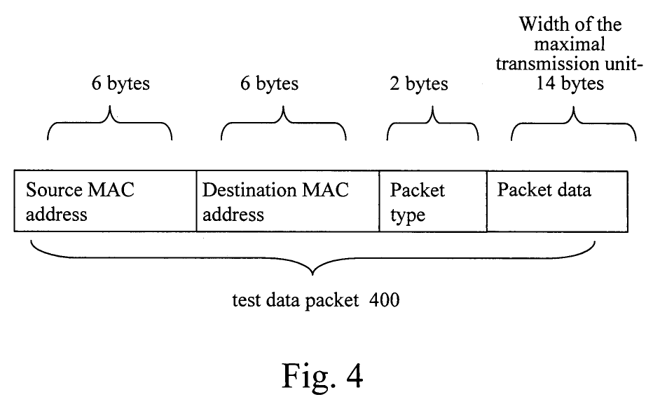

FIG. 4 is a schematic view of fields of test data packets. Referring to FIG. 4, the fields of a test data packet 400 include a source MAC address, a destination MAC address, a packet type field for discriminating the type of packets, and transmitted packet data. In the data link layer, the MTU of the transmitted packets (width of the MTU) is determined. In this embodiment, the width of the MTU can be 64, 128, 256, 512, 1024, 1280, and 1500 bytes. Referring to FIG. 3 again, after the MAC address of the network card under test is filled in the source MAC address and the destination MAC address of the test data packet 400 through the network card driver of the data link layer 330, it can be transmitted to the network card 120. The function of the network card 120 on a physical layer 340 is to convert the data packets into electric signals and then transmit the electric signals to the network. After converting the test data packets 400 into electric signals, the network card 120 can receive the transmitted electric signals through the test loop formed by the external network card testing set 110, so as to convert the electric signals into test data packets 400.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A network card testing system, for testing efficacy of a network card for transceiving/receiving and processing packets, comprising:
a network card testing set, comprising:
a network cable connector; and
a plurality of twisted pairs, wherein one ends of the twisted pairs are disposed in a stagger arrangement and inserted in the network cable connector, and the other ends connect the twisted pairs with one another respectively;
a network card, having at least one connection port, and disposed in a computer or an electronic device, wherein the connection port is connected to the network cable connector, so as to form a test loop; and
a network card testing software, for executing the following steps through the computer or the electronic device:
generating test data packets with different lengths according to network card information and a plurality of testing strategies;
sending the test data packets to the network card through a lower level driver (LLD);
receiving the test data packets sent back to the network card through the test loop; and
calculating test results according the sent-back test data packets.

2. The network card testing system as claimed in claim 1, wherein the network card information comprises network card name, network card MAC address, and network card maximal transmission unit (MTU).

3. The network card testing system as claimed in claim 2, wherein the width of the network card MTU is selected from the aggregate consisting of 64, 128, 256, 512, 1024, 1280, and 1500 bytes.

4. The network card testing system as claimed in claim 1, wherein the testing strategies are selected from among a pressure test, a packet lost rate test, and a network simulation test.

5. The network card testing system as claimed in claim 4, wherein when the testing strategy is the pressure test, the MTU with the maximal width is adopted.

6. The network card testing system as claimed in claim 4, wherein when the testing strategy is the packet lost rate test, the MTU with the minimal width is adopted.

7. The network card testing system as claimed in claim 4, wherein when the testing strategy is the network simulation test, the length of the MTU is dynamically adjusted.

8. The network card testing system as claimed in claim 1, wherein the LLD is selected from the aggregate consisting of a Network Driver Interface Standard (NDIS) protocol and a PF_PACKET Socket procedure.

9. The network card testing system as claimed in claim 1, wherein the test data packets are raw packets sent through a data link layer.

10. The network card testing system as claimed in claim 1, wherein the test results comprise throughput of transmitting the packets and packet lost rate.
